(19) United States
(12) Patent Application Publication
(10) Pub. No.: US 2012/0059838 A1
(43) Pub. Date: Mar. 8, 2012

(54) PROVIDING ENTITY-SPECIFIC CONTENT IN RESPONSE TO A SEARCH QUERY

(75) Inventors: ALEC JOHN BERNTSON, SEATTLE, WA (US); NITIN AGRAWAL, REDMOND, WA (US); SONG ZHOU, Redmond, WA (US); YATHARTH SARAF, Bellevue, WA (US); TARUN JOSHI, Redmond, WA (US); KIERAN RICHARD MCDONALD, SEATTLE, WA (US); YOHANNES TSEGAY, BELLEVUE, WA (US); NIPOON MALHOTRA, BELLEVUE, WA (US); MUHAMMAD AATIF AWAN, BELLEVUE, WA (US); SANAZ AHARI, BELLEVUE, WA (US); TIMOTHY CHARLES HOAD, REDMOND, WA (US)

(73) Assignee: MICROSOFT CORPORATION, REDMOND, WA (US)

(21) Appl. No.: 12/876,638

(22) Filed: Sep. 7, 2010

(51) Int. Cl. G06F 17/30

(52) U.S. Cl. 707/759; 707/E17.014

(57) ABSTRACT

Computer-readable media, computer systems, and computing devices facilitate providing entity-specific content to a user in response to a search request. A search request is received from a user and determined to be related to an entity. Domains associated with the entity are also identified. The search service identifies a set of potential answers and uses the potential answers to generate a set of reformulation queries, which are used to query answer services. Answers returned by the answer services are ranked and bound to an entity card, which is subjected to a quorum checking process that facilitates optimization of the use of allocated screen real estate associated with the entity card. A representation of the entity card is presented on a search-results page.

### BACKGROUND

Many of the searches that users perform in various environments are related to entities—people, places, and things. For instance, a user searching for an entity may be looking for an official site associated with it (e.g., the “Avatar” movie's official site) or related information for the entity (e.g., weather and attractions for Seattle). Furthermore, there may be a number of intents users have for a given entity. That is, for example, when searching for an actor, a user may be interested in looking at images of that actor, visiting the actor's official site, or reviewing a list of the actor's recent movies. The traditional practice of returning a set of Web uniform resource locators (URLs) in response to such entity queries often results in the user having to read through a list of web pages to find the one that would have the desired information. Sometimes the information may not be found in any of the web pages and the user must select a domain for the search engine (e.g., videos, images, etc.). In many cases, the user spends an unnecessary amount of time finding the information and has to do a fair amount of guess-work to determine where to obtain the information. This results in a poor user experience, longer task-completion time, and less successful search sessions.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

In embodiments of the invention, entity-specific content (e.g., information) is presented to a user (in response to a user search query) using a representation of an entity card. By utilizing entity cards, a search service can help the user avoid having to look at different web results, answers or other verticals to find information related to an entity by providing a cohesive experience that brings together information related to the entity in one place.

According to embodiments of the invention, a search service identifies queries related to entities by utilizing a combination of classifiers and dictionaries for different entity categories (e.g., groupings of people, places, and things) and the queries associated with these entities. Because some queries can be ambiguous (e.g., can potentially be related to multiple entities), embodiments of the invention facilitate disambiguating entities by using offline data to find a common intent of the query and to trigger an entity card for the entity corresponding to that intent.

In embodiments, when an entity and the category to which it belongs are identified (e.g., Seattle, which belongs to the category including cities), the search service generates an execution plan that includes a list of answers to be generated and a list of query reformulations for use in obtaining each of the answers from answer services. For example, an execution plan for cities may include an image or slide show, weather information, information regarding neighborhoods, identification of attractions, and links to local newspapers. According to embodiments, an execution plan engine calls the answers with reformulated queries by submitting queries to answer services. When the answers have been returned, they can be ranked based on any number of features including, for example, click data and configuration rules. In embodiments, the search service also performs quorum checking to ensure that there is enough content included in the entity-card to render a good user experience.

### BRIEF DESCRIPTION OF THE DRAWINGS

Embodiments of the invention are described in detail below with reference to the attached drawing figures, wherein:

FIG. 1 is a block diagram of an exemplary computing device suitable for implementing embodiments of the invention;

FIG. 2 is a block diagram of an exemplary network environment suitable for use in implementing embodiments of the invention;

FIG. 3 is a block diagram depicting an illustrative operating environment in accordance with embodiments of the invention;

FIG. 4 is a schematic diagram depicting an illustrative search-results page that includes an entity card in accordance with embodiments of the invention;

FIG. 5 is a schematic diagram depicting another illustrative search-results page that includes an entity card in accordance with embodiments of the invention;

FIG. 6 is a flow diagram depicting an illustrative method of presenting entity-specific content to a user in accordance with embodiments of the invention;

FIG. 7 is a flow diagram depicting another illustrative method of presenting entity-specific content to a user in accordance with embodiments of the invention; and

FIG. 8 is a flow diagram depicting another illustrative method of presenting entity-specific content to a user in accordance with embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention described herein include computer-readable media having computer-executable instructions for performing a method of presenting entity-specific content to a user. Embodiments of the illustrative method include receiving a search query that is submitted to the search service by a user and determining that the search query is related to an entity. In embodiments, the search service generates a reformulated query based on the search query and submits the reformulated query to an answer service. An answer is received and presented to the user.

In a second illustrative embodiment, computer-executable instructions cause a computing device to perform a method of presenting entity-specific content to a user. In embodiments, the method includes receiving a search query and determining that the search query is related to an entity. According to various embodiments, the search service identifies a set of potential answers corresponding to the search query and selects an answer service based on the set of potential answers. In embodiments, the illustrative method further includes generating a reformulated query based on the search query and generating an execution plan, which may include a plan for submitting an answer query to the selected answer service. The answer query is provided to the answer service. In various embodiments, an answer is received from the answer service and provided, by the search service, on a search-results page.

In a third illustrative embodiment, a set of computer-executable instructions provides an exemplary method of presenting entity-specific content to a user. In embodiments, the illustrative method includes receiving a search query, determining that the search query is related to an entity, generating a set of reformulated queries based on the search query, and querying a set of answer services using the set of reformulated queries. In embodiments, the illustrative method further includes receiving a set of answers, ranking the set of answers, and identifying a first subset of the set of answers, where the first subset of answers is to be presented to the user. According to various embodiments, the search service binds the subset of answers to an entity card, and provides a search-results page that includes a representation of the entity card.

Various aspects of embodiments of the invention may be described in the general context of computer program products that include computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including dedicated servers, general-purpose computers, laptops, more specialty computing devices, and the like. The invention may also be practiced in distributed computing environments where tasks are performed by remote-processing devices that are linked through a communications network.

Computer-readable media include both volatile and nonvolatile media, removable and nonremovable media, and contemplate media readable by a database, a processor, and various other networked computing devices. By way of example, and not limitation, computer-readable media include media implemented in any method or technology for storing information. Examples of stored information include computer-executable instructions, data structures, program modules, and other data representations. Media examples include, but are not limited to RAM, ROM, EEPROM, flash memory and other memory technology, CD-ROM, digital versatile discs (DVD), holographic media and other optical disc storage, magnetic cassettes, magnetic tape, magnetic disk storage, and other magnetic storage devices. These technologies can store data momentarily, temporarily, or permanently.

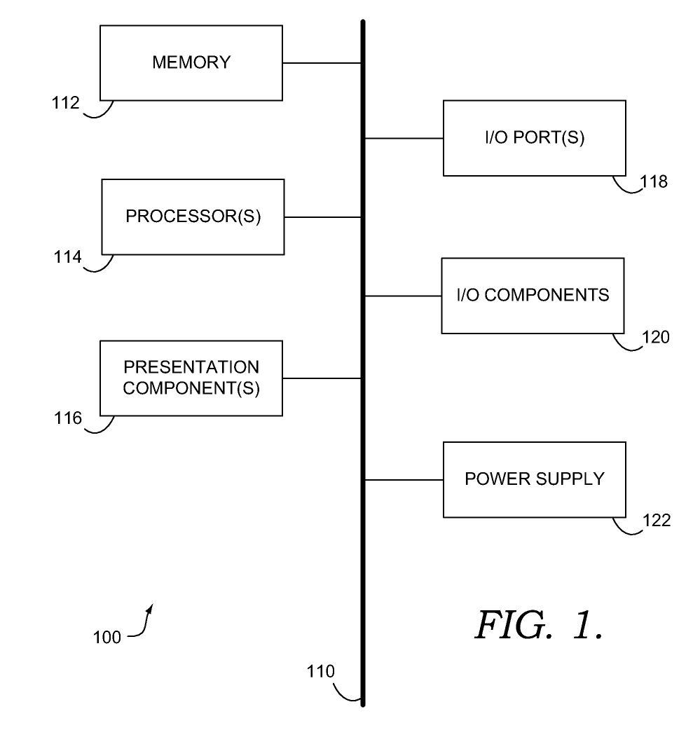

An exemplary operating environment in which various aspects of the present invention may be implemented is described below in order to provide a general context for various aspects of the present invention. Referring initially to FIG. 1, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The computing device 100 includes a bus 110 that directly or indirectly couples the following devices: a memory 112, one or more processors 114, one or more presentation components 116, input/output (I/O) ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG.

1 and reference to “computing device.”

The memory 112 includes computer-executable instructions (not shown) stored in volatile and/or nonvolatile memory. The memory may be removable, nonremovable, or a combination thereof. Exemplary hardware devices include solid-state memory, hard drives, optical-disc drives, etc. The computing device 100 includes one or more processors 114 coupled with a system bus 110 that read data from various entities such as the memory 112 or I/O components 120. In an embodiment, the one or more processors 114 execute the computer-executable instructions to perform various tasks and methods defined by the computer-executable instructions. The presentation component(s) 116 are coupled to the system bus 110 and present data indications to a user or other device. Exemplary presentation components 116 include a display device, speaker, printing component, and the like.

The I/O ports 118 allow computing device 100 to be logically coupled to other devices including the I/O components 120, some of which may be built in. Illustrative components include a microphone, joystick, game pad, satellite dish, scanner, printer, wireless device, keyboard, pen, voice input device, touch-input device, touch-screen device, interactive display device, or a mouse. The I/O components 120 can also include communication connections that can facilitate communicatively connecting the computing device 100 to remote devices such as, for example, other computing devices, servers, routers, and the like.

Web searching has become a common technique for finding information. Popular search engines allow users to perform broad-based Web searches according to search terms entered by the users in user interfaces provided by the search engines (e.g. search engine web pages displayed at client devices). A broad-based search can return results that may include information from a wide variety of domains (where a domain refers to a particular category of information).

In some cases, users may wish to search for information that is specific to a particular domain. For example, a user may seek to perform a music search or to perform a product search. Such searches (referred to as “domain-specific searches”) are examples of searches where a user has specific query intent for information from a specific domain in mind when performing the search (e.g. search for a particular song or recording artist, search for a particular product, and so forth). Domain-specific searching can be provided by a vertical search service, which can be a service offered by a general-purpose search engine, or alternatively, by a vertical search engine. A vertical search service provides search results from a particular domain, and typically does not return search results from domains un-related to the particular domain. One example of a specialized type of vertical-search service is referred to herein as an “instant-answer service” (or, interchangeably, an “answer service”).

An “instant answer” (referred to herein, interchangeably, as an “answer”) refers to a search result that is a response to a search query that is provided to a user on the main search results page. That is, a user is presented with domain-specific content on the search results page in response to a query, whereas the user might otherwise be required to select a link within the search results page to navigate to another webpage and, thereafter, search further for the desired information. For example, assume a user search query is “weather in Seattle.” An algorithm result within a search results page might include a URL to weather.com. In such a case, the user can select the URL, transfer to that webpage, and, thereafter, input Seattle to obtain the weather in Seattle. By comparison, an “answer” presented on the search results page contains the weather for Seattle such that a user is not required to navigate to another webpage to find the answer to the intended query. As can be appreciated, an answer might pertain to any subject matter including, for example, weather, news, area codes, conversions, dictionary terms, encyclopedia entries, finance, flights, health, holidays, dates, hotels, local listings, math, movies, music, shopping, sports, package tracking, and the like. An answer can be in the form of an icon, a button, a link, text, a video, an image, a photograph, an audio, a combination thereof, or the like.

According to embodiments of the invention, answers are presented to users using entity cards. As the term is used herein, an “entity card” is a data structure that defines a particular presentation or layout of entity-specific content. The entity-specific content contained in an entity card can include answers, algorithmic search results, query suggestions, and the like. In embodiments, a search service generates an entity card based on domain-intent inferences made from the user search query and presents a representation of the entity card on a search-results page.

A query-intent classifier can be used to determine whether or not a query received by a search engine should trigger a vertical search service such as, for example, an entity-card service. For example, a dictionary-definition intent classifier can determine whether or not a received query likely is related to a dictionary-definition search. If the received query is classified as relating to a dictionary-definition search, then the corresponding vertical search service can be invoked to identify search results in the dictionary-definition search domain (which can include websites relating to dictionary-definition searching, for example). In one specific example, a dictionary-definition intent classifier may classify a query containing the search phase “define fidelity” as being positive as a dictionary-definition intent search, which would therefore trigger a vertical search for dictionary definitions of words and phrases including “fidelity.” On the other hand, the dictionary-definition intent classifier might classify a query containing the search phrase “Fidelity” (which is a name of a well-known financial organization) as being negative for (or as not being positive for) a dictionary-definition intent search, and therefore, would not trigger a vertical search service. Because “Fidelity” is the name of a well-known company, the presence of “fidelity” in the search phrase, taken alone, should not necessarily trigger a dictionary-definition-related domain-specific search or entity card.

The term “query” refers to any type of request containing one or more search terms that can be submitted to a search engine (or multiple search engines) for identifying search results based on the search term(s) contained in the query. The “items” that are identified by the queries in the data structure are representations of search results produced in response to the queries. For example, the items can be uniform resource locators (URLs) or other information that identify addresses or other identifiers of locations (e.g., websites) that contain the search results (e.g., web pages).

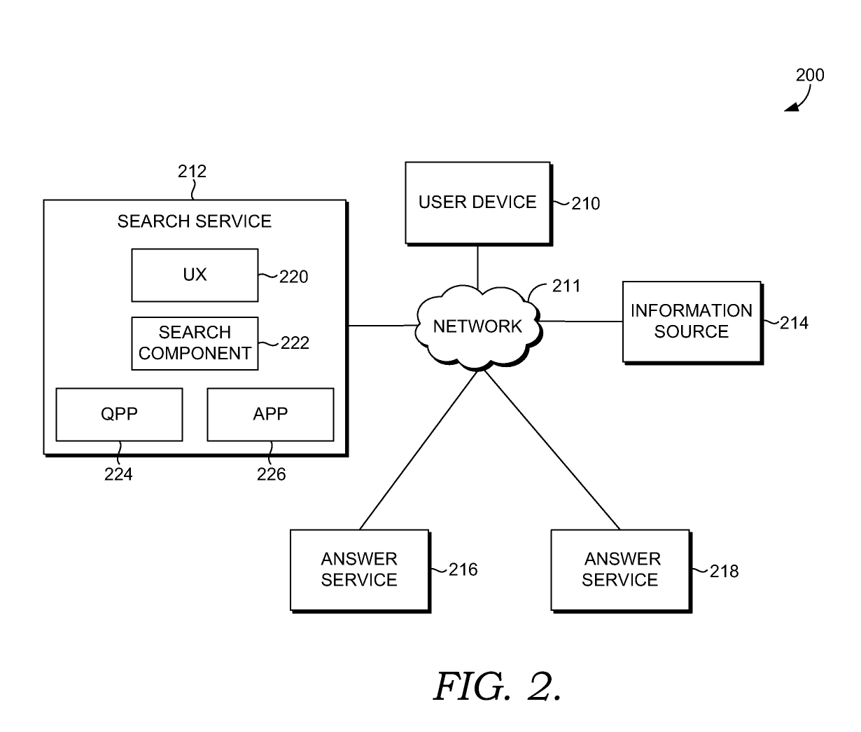

Turning now to FIG. 2, a block diagram of an exemplary network environment 200 suitable for use in implementing embodiments of the invention is shown. The network environment 200 includes a user device 210, a network 211, a search service 212, an information source 214, and answer services 216 and 218. The user device 210 communicates with the search service 212 through the network 211, which may include any number of networks such as, for example, a local area network (LAN), a wide area network (WAN), the Internet, a cellular network, a peer-to-peer (P2P) network, a mobile network, or a combination of networks. The network environment 200 shown in FIG. 2 is an example of one suitable network environment and is not intended to suggest any limitation as to the scope of use or functionality of embodiments of the inventions disclosed throughout this document. Neither should the exemplary network environment 200 be interpreted as having any dependency or requirement related to any single component or combination of components illustrated therein.

The user device 210 can be any kind of computing device capable of allowing a user to submit a search query to the search service 212 and to receive, in response to the search query, a search results page from the search service 212. For example, in an embodiment, the user device 210 can be a computing device such as computing device 100, as described above with reference to FIG. 1. In embodiments, the user device 210 can be a personal computer (PC), a laptop computer, a workstation, a mobile computing device, a PDA, a cell phone, or the like.

The search service 212 provides searching services to users. In embodiments, the search service 212 provides searching services for searching for content in an environment in which content can be stored such as, for example, the Internet, a local area network (LAN), a wide area network (WAN), a database, a computer, or the like. The search service 212, according to embodiments, can be implemented as server systems, program modules, virtual machines, components of a server or servers, networks, and the like.

In an embodiment, the user device 210 is separate and distinct from the search service 212 and/or the other components illustrated in FIG. 2. In another embodiment, the user device 210 is integrated with the search service 212. For clarity of explanation, we shall describe embodiments in which the user device 210 and the search service 212 are separate, while understanding that this may not be the case in various configurations contemplated within the present invention.

With continued reference to FIG. 2, the user device 210 communicates with the search service 212 to facilitate a search for content. In embodiments, for example, a user utilizes the user device 210 to search for content available via the network 211. For instance, in some embodiments, the network 211 might be the Internet, and the user device 210 interacts with the search service 212 to search for content stored on servers associated with websites. In other embodiments, for example, the network 211 might be an enterprise network associated with a company. In these embodiments, the user device 210 interacts with the search service 212 to search for content stored on various nodes within the enterprise network. It should be apparent to those having skill in the relevant arts that any number of other implementation scenarios may be possible, as well.

In embodiments, the search service 212 receives search queries, i.e., search requests, submitted by a user via the user device 210. Search queries received from a user can include search queries that were manually or verbally inputted by the user, queries that were suggested to the user and selected by the user, and any other search queries received by the search service 212 that were somehow approved by the user. In other embodiments, the search service 212 can receive search queries originating at other locations. For instance, query suggestion modules (not shown) associated with the search service 212 can provide search queries in response to user selection of query suggestions, and the like. Generally, the search service 212 can receive search queries from any number of people, locations, organizations, and devices.

The search service 212 may be or include, for example, a search engine, a crawler, or the like. The search service 212, in some embodiments, is configured to perform a search using a query submitted through the user device 210. In various embodiments, the search service 212 can provide a user interface for facilitating a search experience for a user communicating with the user device 210. In an embodiment, the search service 212 monitors searching activity, and can produce one or more records or logs representing search activity, previous queries submitted, search results obtained, and the like. These services can be leveraged to improve the searching experience in many different ways. According to various embodiments of the invention, the search service 212 references an associated web index (not illustrated for brevity and clarity of description) to identify search results that are relevant to a search query received from a user.

In an embodiment, the search service 212 is configured to receive a submitted query and to use the query to perform a search. In an embodiment, upon identifying search results that satisfy the search query, the search service 212 returns a set of search results to the user device 210 by way of a graphical interface such as a search-results page. A set of search results includes representations of content or content sites (e.g., web-pages, databases, or the like that contain content) that are deemed to be relevant to the user-defined search query. Search results can be presented, for example, as content links, snippets, thumbnails, summaries, and the like. Content links refer to selectable representations of content or content sites that correspond to an address for the associated content. For example, a content link can be a selectable representation corresponding to a uniform resource locator (URL), IP address, or other type of address. That way, selection of a content link can result in redirection of the user's browser to the corresponding address, whereby the user can access the associated content. One commonly used example of a content link is a “hyperlink” (referred to herein, interchangeably, as an “anchor”).

According to embodiments of the invention, a search-results page can include a number of different types of content. For example, the search-results page can include algorithmic search results, query suggestions, related searches, historical information, sponsored search results, advertisements, and entity cards. According to embodiments of the invention, and as described in more detail below, the search service 212 can retrieve answers from answer services 216 and 218 and provide the answers on a search-results page.

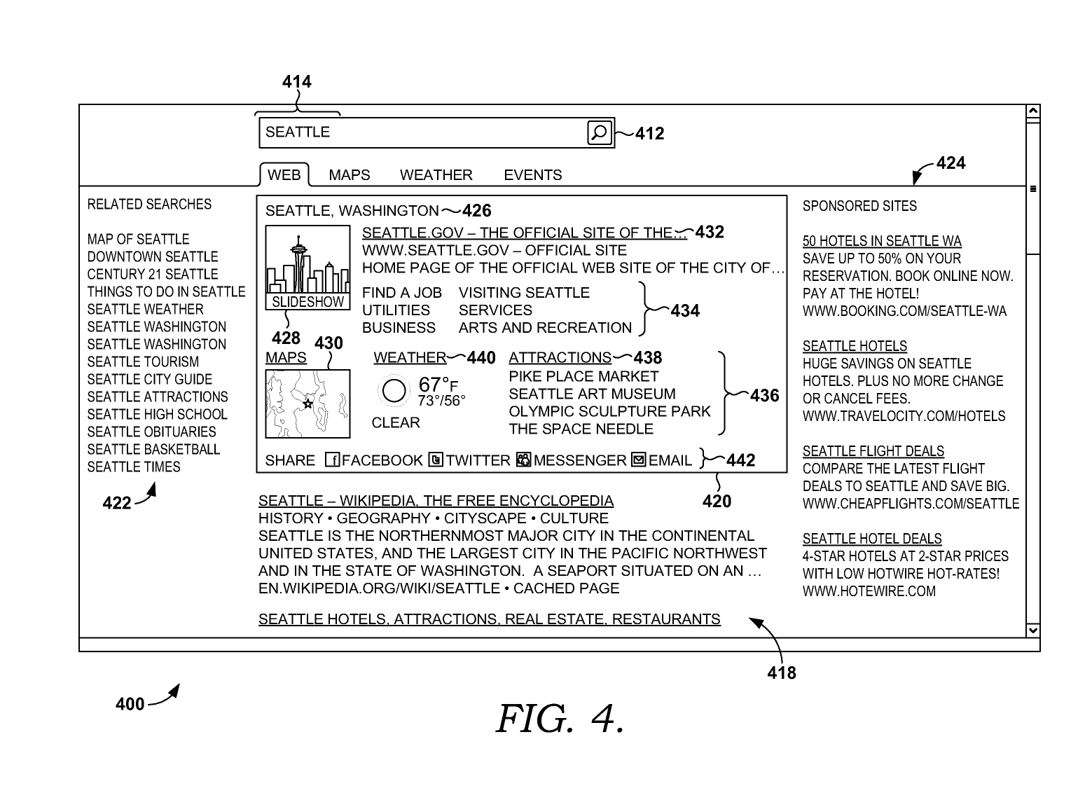

Turning briefly to FIG. 4, an exemplary search-results page 400 is illustrated. As shown in FIG. 4, the illustrative search-results page 400 includes the search text and input box 412 into which a user can type a search query 414. For example, in the illustrative search-results page 400 illustrated in FIG. 4, a user has typed the search query “Seattle” into the search text input box 412. As it is further illustrated in FIG. 4 the illustrative search-results page 400 includes a set 418 of algorithmic search results, a representation 420 of an entity card, a set 422 of related searches and a set 424 of sponsored sites. In an embodiment, any number of other types of information can be included on the search-results page 400. Additionally, according to embodiments of the invention, other arrangements, layouts, and representations of content can be included in search-results page 400.

As is illustrated in FIG. 4, the representation 420 of the entity card includes a displayed entity name 426, an image 428 associated with the entity, a hyperlink 432 to an official site corresponding to the entity, additional hyperlinks 434 associated with the official site 432, and a set 436 of answers associated with the entity. For the purposes of the illustration depicted in FIG. 4, it is assumed that the associated search service has applied one or more classifiers to the user search query 414 and determined that the user search query 414 is related to a particularly entity—namely the city of Seattle, Wash.

As is further illustrated in FIG. 4, the set 436 of answers includes a map answer 430, a weather answer 440, and an attractions answer 438. As illustrated, embodiments of the invention include presenting, for example, hyperlinks to further information associated with the answers 430, 438, 440, such as, for example, maps, images, weather indications, samples of information related to an answer, and the like. Additionally, the representation 420 of the entity card includes links 442 for sharing the entity card or the content contained therein.

According to various embodiments of the invention, the content displayed within the representation 420 of the entity card is selected and arranged during a process referred to as quorum checking. During quorum checking, the available screen real estate within the area allocated for display of a representation of the entity card is examined to determine which content (e.g., answers, algorithmic results, etc.) should be displayed. In embodiments, a quorum checking process can be subject, in part, to a set of rules, conditions, preferences, and the like. For instance, in some embodiments, an entity card might be required to include a title (e.g., an entity name), one or two algorithmic results, at least one image, and at least one item of content corresponding to a certain intent domain. In embodiments, any number of different requirements, rules, conditions, and the like can be associated with generating an entity card and binding content to the entity card. In some embodiments, for example, particular arrangements of content on the entity card can be predetermined or varied, and in some cases, can be determined based on a number of different factors.

In an embodiment, quorum checking includes determining which content should be included in an entity card, which content is relevant enough to be provided as overflow content, and which content should not be provided to the user. Overflow content refers to content that meets criteria for inclusion in an entity card but is not included (e.g., because other, higher ranked content is included, leaving no room in the area allocated for the representation of the entity card). In embodiments, overflow content can be provided on a search-results page in any number of different locations, all of which are considered to be within the ambit of the invention.

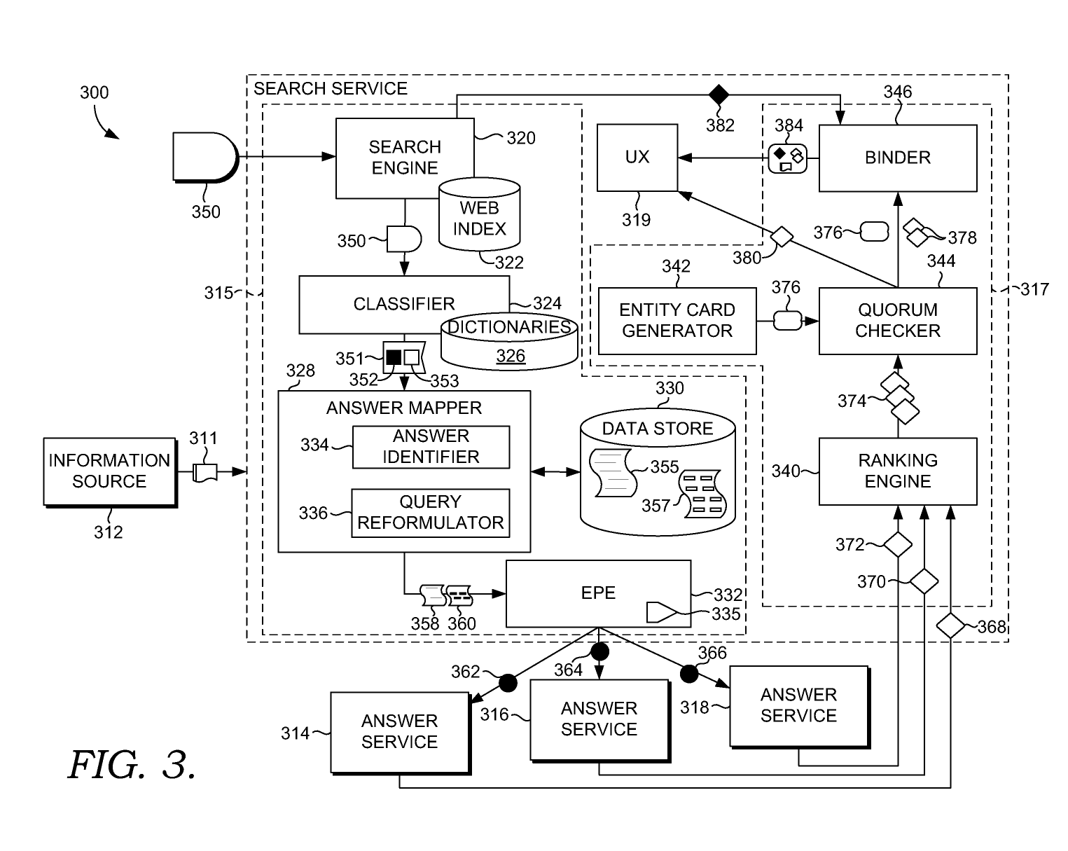

Thus, in embodiments, a quorum checking component (e.g., quorum checker 344 of FIG. 3, more fully described herein below) receives an entity card from an entity card generator and receives a set of answers and other content relevant to a user search query. The quorum checking component identifies, using ranking results, rules, conditions, algorithms, or the like, a first subset of the set of answers and other content. The first subset of content is the content that will be displayed in a representation of the entity card on a search-results page. In embodiments, the quorum checking component identifies a second subset of the answers and other content. This second subset of content is the overflow content. In some embodiments, the quorum checking component (or a different component) binds the first subset of content to the entity card according to some arrangement. The entity card (with the first subset of content bound to it) is provided to, for example, a search component, or other component that can facilitate rendering a representation of the entity card on a user's computing device. In embodiments, the second subset of content can be provided to the search component or other component along with an answer map (e.g., a data structure specifying a search-results page layout) that establishes the relative locations on the search-results page at which the entity card and the overflow content is to be displayed, resulting, for example, in a search-result page layout such as the layout of search-results page 400, illustrated in FIG. 4.

Returning to FIG. 2, as illustrated, the search service 212 includes a user interface component (UX) 220, a search component 222, a query processing pipeline (QPP) 224, and an answer processing pipeline (APP) 226. According to embodiments of the invention, the search service 212 can include any number of other components not illustrated. In some embodiments, one or more of the illustrated components 220, 222, 224, and 226 can be integrated into a single component or can be divided into a number of different components. Components 220, 222, 224, and 226 can be implemented on any number of machines and can be integrated, as desired, with any number of other functionalities or services.

The UX 220 includes hardware, software, and/or firmware for facilitating display of a graphical user interface on a display device coupled with the user device 210. In various embodiments, the UX 220 is integrated with the search component 222, and in some embodiments, the UX 220 and the search component 222 are distinct components. The user device 210 communicates with the UX 220 to access search services and features hosted by the search service 212. In embodiments, the UX 220 includes logic that facilitates communications between any number of components of the search service 222 and the user device 210 or other devices, management components, and the like by translating communications between various communication protocols, hosting communication links, and the like.

The search component 222 includes a search engine, web index, and any other components necessary for performing searching services. In embodiments, the search component 222 receives search queries and processes the queries to return algorithmic search results. In some embodiments, the search component 222 can host a graphical user interface that facilitates interaction between the user device 210 and the search service 212. In some embodiments, the search component 222 can include profile services that allow a user to set preferences, configure services, and the like. In an embodiment, a user can select various features, arrangements, triggers, and the like related to entity card services. Any number of other functions and services can be integrated within the search component 222, as will be recognized by those having skill in the relevant arts.

According to embodiments of the invention, the QPP 224 determines whether a search query is related to an entity. If the search query is related to an entity, the QPP 224 identifies the entity and domains (e.g., categories) to which the entity belongs. Further, the QPP 224, in embodiments, identifies potential answers corresponding to the search query, generates reformulated queries based on the search query and, using an execution plan, provides the reformulated queries to answer services 216 and 218 to obtain answers corresponding to the entity. The answer services 216 and 218 provide the answers to the APP 226 for ranking and inclusion in an entity card.

In some embodiments, the QPP 224 provides the entity name to the APP 226. In some embodiments, for example, the QPP 224 surfaces an entity-card trigger flag, categories for the query, the dominant category, the entity name, a canonical query (explained in further detail below), and any number of official sites associated with the query. As the term is used herein, a “canonical query” refers to a string that represents an entity and is either the most commonly used query for the entity or the most general form of that entity. For example, the canonical form of the queries {Honda accord car}, {Honda accord sedan} and {Honda accord 2009} might be {Honda accord}. In embodiments, each dictionary query has an associated canonical form. A canonical form associated with a query (or entity) can be determined in any number of ways. In an embodiment, for example, an answer mapper 328 (FIG. 3) generates a cluster of queries to represent the same broad entity and selects the most frequently occurring query in the cluster to be the canonical form for all queries in that cluster. In embodiments, clusters can be generated by referencing all queries that have common substrings. In other embodiments, the canonical form of a query can be the query itself.

The dominant category can be used, for example, by the APP 226 to assist with quorum checking. In embodiments, the entity name is used by the QPP 224 to create an answer response for the title of the entity card, which the APP 226 can add to the entity card. In further embodiments, official sites can be utilized to import the associated snippet and algorithmic result into the entity card from the search component 220. In other embodiments, official sites, snippets, and the like can be obtained from other sources such as, for example, the information source 214, the answer services 216 and 218, or any number of other sources (e.g., web logs, a web index, etc.).

The APP 226 sends entity-card responses to the UX 220. In embodiments, the APP 226 includes logic for performing quorum checking, answers ranking, and packaging of the response using an appropriate communication protocol. In embodiments, ranking of answers can be based on a static or dynamic list for each entity-card dictionary. In some embodiments, for example, the data utilized by the APP 226 for quorum checking and answer ranking is maintained in configuration files specifying ordered lists of answers for each entity-card dictionary. The APP 226 can use the configuration files to determine whether an entity-card service is triggered and, accordingly, can include an entity-card answer response in a search-results page layout, which is provided to the UX 220.

In embodiments, the APP 226 also ties a number of algorithmic results to the entity card. For example, the APP 226 can retrieve any number (e.g., one or two or more) of algorithmic results from the search component 222. During quorum checking, the APP 226 can determine how many of the retrieved algorithmic results should be included in the entity card. Any number of different rules, conditions, factors, heuristics, and the like can be used to make this determination. In embodiments, the APP 226 also retrieves hyperlinks, content, and other information associated with official sites associated with entities and can include the hyperlinks, content, and information (or any portion thereof) in the entity card. According to embodiments of the invention, the APP 226 utilizes automated algorithms to retrieve information corresponding to official sites for entities. In embodiments, the APP 226 references sources like Wikipedia, search logs, and the like to identify official sites and obtain content, information, and hyperlinks associated therewith. In this manner, the APP 226 extracts official sites while disambiguating entities, allowing for defect management services to correct mistakes made by the algorithms.

Turning now to FIG. 3, an illustrative operating environment 300 is depicted. The illustrative operating environment 300 includes a search service 310, an information source 312, and answer services 314, 316, and 318. The illustrative operating environment 300 shown in FIG. 3 is an example of one suitable operating environment 300 and is not intended to suggest any limitation as to the scope of use or functionality of embodiments of the inventions disclosed throughout this document. Neither should the illustrative operating environment 300 be interpreted as having any dependency or requirement related to any single component or combination of components illustrated therein.

As illustrated in FIG. 3, the search service 310 includes a QPP 315, an APP 317, and a user interface component (UX) 319. In embodiments, the search service 310 can include any number of other components, modules, and the like. In some embodiments, any two or more of the QPP 315, the APP 317, and the UX 319 can be integrated as a single component. In other embodiments, any of the QPP 315, the APP 317, and the UX 319 can be distinct components. In embodiments, the components of the QPP 315 and the APP 317 can be varied in any number of ways, as well.

As illustrated, the QPP 315 includes a search engine 320, a web index 322, a classifier 324, dictionaries 326, an answer mapper 328, a data store 330, and an execution plan engine (EPE) 332. In some embodiments, the search engine 320 can be included in a search component (not illustrated) that is separate from the QPP 315. According to various embodiments, any number of the components 320, 322, 324, 326, 328, 330, and 328 can be integrated or can be implemented within some other component such as, for example, the APP 317.

The search engine 320 interacts with the web index 322 to process user search queries. In embodiments, the search engine 320 runs various algorithms, using a search query as input, to identify entries in the web index 322 that satisfy the search query. These results are referred to as algorithmic results. Although it is not illustrated in FIG. 3, the APP 317 can retrieve algorithmic results from the search engine 320. Such algorithmic results can be utilized for providing content in an entity card such as, for example, entity card titles, official sites, and the like.

The classifier 324 interacts with the dictionaries 326 to determine whether search queries are related to entities. Additionally, in embodiments, the classifier 324 also identifies domains (i.e., categories) associated with search queries, related search queries, related entities, and the like. According to various embodiments of the invention, the classifier 324 is a binary query-intent classifier for determining a domain associated with a user query. In other embodiments, the classifier 324 can be any type of classifier useful for categorizing incoming user search queries. The classifier 324 can take any number and type of data as inputs for classifying incoming queries. In embodiments, the classifier 324 can be utilized to classify a query as belonging to one particular domain or not. In other embodiments, the classifier 324 can be utilized to identify a domain to which the query corresponds. According to various embodiments of the invention, the classifier 324 can be used for any number of reasons and can be implemented according to any number of configurations in accordance with embodiments of the invention.

The answer mapper 328, as shown in FIG. 3, includes an answer identifier 334 and a query reformulator 336. In embodiments, the answer mapper 328 can include any number of other components as well. For example, in an embodiment, the answer mapper 328 includes functionality for retrieving information 311 from the information source 312. In embodiments, the answer mapper 328 includes functionality for referencing algorithmic search results, query suggestions, web logs, user profiles, and the like. In embodiments, the answer identifier 334 identifies a set of potential answers or other responses to a user search query. The query reformulator 336 generates sets of reformulated queries based on user search queries. Such query reformulation may take place in a number of different ways. For instance, upon receiving the user search query “Seattle, Wash.,” the query reformulator 336 may reformulate the query to “Seattle, Wash. weather,” for instance, if weather in Seattle is among the most frequently conducted searches involving the originally queried term or terms. The reformulated query would then trigger the weather instant answer. In other instances, user queries may be ambiguous with respect to potential entities, for example, because they share a name with another entity or concept. For instance, the user search query “Jesse Jackson” may refer to the musician or to Michael Jackson's father, and the user search query “spoon” may refer to the band or the utensil. In such an instance, upon receiving the ambiguous user query, disambiguation may be conducted by using offline data to find a common intent of the query and to trigger an entity card for the entity corresponding to that intent (that is, the query may be reformulated to “Jesse Jackson musician” or “spoon band”). In embodiments, reformulated queries can be designed to return particular answers, answers associated with particular domains, and the like.

In embodiments, a query suggestion service can be utilized to generate related entities for dictionary queries. In some embodiments, the answer mapper 328 references query suggestion lists generated by the query suggestion service. In an embodiment, the answer mapper 328 retains only those suggestions that are also part of the same dictionary and that do not contain the dictionary query as a substring or vice versa (to eliminate narrow query suggestions). In embodiments, the resulting information can be validated such as, for example, by manual checking of data generated for a random set of queries, by referencing live site clickthrough metrics, and the like.

In some embodiments, for example, coverage can be measured, at least in part, due to imposition of acceptable ranges for related entity identification. For instance, in an embodiment, a minimum number of related entities required may be set, for example, at three, while a maximum of four may be imposed. In various embodiments, any number of different values can be established for these maxima and minima. In embodiments, the answer mapper 328 maps a query to its canonical form and, using the related entities from the canonical form, related entities can be identified.

Additionally, in some embodiments, the answer mapper 328 can apply specific heuristics for some dictionaries to facilitate coverage of the data. These heuristics can be generated based on the data for each entity card dictionary. Also, in some embodiments, the answer mapper 328 uses other sources of data as fallback. The answer mapper 328 can, in embodiments, dedupe the results with related searches. This can be done offline with precedence given to related entities. The related entities can, according to various embodiments, be included in a list of potential answers identified by answer mapper 328. In some further embodiments, snippet correlation can be utilized to reformulate queries. In this manner, the answer mapper 328 can increase the probability that the query reformulations result in answers related to the same entity in the entity card.

According to various embodiments of the invention, the query reformulator 336 generates reformulated queries that are designed such that the answers that fire in the entity card execution plan all fire for the same entity and not for different ones (in the case of ambiguous queries). In some embodiments, the search service 310 provides all of the information available to the QPP 315 about the query to the answer services 314, 316, and 318 such as, for example, by way of an augmentation, a modification of the query string, or the like. In embodiments, the query reformulator 336 also generates reformulated queries that are designed such that the answer services 314, 316, and 318, return content associated with the entity. To accomplish this, the query reformulator 332 can include knowledge of each answer service's grammar, protocols, and the like. In embodiments, for example, providers of the search service 310 can work with the providers of the answer services 314, 316, and 318, to develop appropriate query reformulations that facilitate maximizing the probability of the reformulated queries causing the answer services 314, 316, and 318, to return desired content.

With continued reference to FIG. 3, the EPE 332 generates an execution plan 335. As the term is used herein, an “execution plan” refers to a data structure that includes information that facilitates obtaining answers from answer services. For example, in embodiments, execution plans are constructed per category (i.e., domain). That is, for a given category, the execution plan will contain a list of answers to trigger along with query reformulations associated with each of the answers. In embodiments, the list of answers per category is editorial and is populated based on a data lookup, such as, for example, by referencing answer dictionaries 355 in the data store 330. In embodiments, the query reformulations are non-editorial and may either be based on a data lookup or on a regular expression substitution.

The APP 317 includes a ranking engine 340, an entity-card generator 342, a quorum checker 344, and a binder 346. In some embodiments, the ranking engine 340 can be included in the search engine 320 that is separate from the APP 317. According to various embodiments, any number of the components 340, 342, 344, and 346 can be integrated or can be implemented within some other component such as, for example, the QPP 315.

In embodiments of the invention, the ranking engine 340 can be utilized to rank answers received from the answer services 314, 316, and 318. The ranking engine 340 can utilize any number of rules, conditions, algorithms, and the like to rank answers according to, for example, relevance to the user search query. Answers are selected from the ranked answers to be bound to an entity card, which is, in embodiments, generated by the entity-card generator 342. In embodiments, the entity-card generator 342 generates entity cards dynamically, while in other embodiments, entity cards can be generated offline and maintained in dictionaries that the entity-card generator 342 accesses to retrieve entity cards.

With continued reference to FIG. 3, the quorum checker 344 can perform any number of tasks and functions to facilitate optimization of the display of content in the representation of an entity card. In embodiments, for example, quorum checking involves checking presence of answers that are required for the given category. Additionally, in embodiments, the quorum checker 344 checks for the presence of a minimum number of answer responses for the given category. In further embodiments, the quorum checker 344 checks that particular types of content or information are included in the entity card.

For instance, in an embodiment, a title answer might be required for all categories. The title answer can include a displayed (e.g., displayable) entity name. In various embodiments, a displayed entity name includes some simple, human-readable string that disambiguates the entity for the user. For example, in an embodiment, the canonical form followed by the dominant dictionary name can be used to disambiguate entity names. Thus, in embodiments, for example, for a query like {jlo}, the search service 310 might end up showing {Jennifer Lopez, actress}. According to embodiments, this may require sufficient granularity in the dictionaries not to allow disambiguation of the query.

However, in some embodiments, for a query like {paris}, the search service 310 determines that it is more appropriate to show {paris, france} instead of {paris}. In that case, the previous approach might not work. Instead, the search service 310, can have special handling for cities and, for example, for all other dictionaries the search service 310 can use the query as the entity name. In various embodiments, the entity name would be based on a data lookup so that the search service 310 can control the entity names for various triggers.

With continued reference to FIG. 3, the binder 346 binds (e.g., attaches, embeds, associates, etc.) answers and other content to entity cards. Any number of protocols, algorithms, schemes, and the like can be utilized to bind content to entity cards. In some embodiments, the binder 346 can be integrated with the UX 319, the search engine 320, or any other number of different components, services, or the like. According to various embodiments of the invention, the binder 346 binds content specified by the quorum checker 344 according to an arrangement specified by the quorum checker 344.

In operation, a user search query 350 is received by the search engine 320. The search engine 320 references the web index 322 to generate algorithmic search results (not illustrated for purposes of brevity). As illustrated, the user search query 350 is fed into the classifier 324, which can reference a number of dictionaries 326 to assist in determining whether the query 350 is related to an entity. The classifier 324 provides an output 351 to the answer mapper 328. As shown in FIG. 3, the output 351 includes an indication 352 of the detected entity and an indication 353 of identified domains associated with the entity.

The answer identifier 334 identifies a set 358 of potential answers based on the output 351 of the classifier 324. In embodiments, the answer identifier 334 references a list 355 of potential answers that are mapped to various entities, domains, queries, or the like. In some embodiments, the answer identifier 334 can also obtain potential answers 311 from the information source 312 (e.g., entity name, official site, etc.). In embodiments, the query reformulator 336 generates a set 360 of reformulated queries. In some embodiments, the reformulated queries can be based on the user search query 350, the set 358 of potential answers, a canonical form of the identified entity, and the like. As illustrated in FIG. 3, the answer mapper provides the set 358 of potential answers and the set 360 of reformulated queries to the EPE 332.

The EPE 332 generates an execution plan 335. In embodiments, execution plans 335 can be generated offline and retrieved from storage by EPE 332. In other embodiments, execution plans are developed per entity or per dictionary query. In some embodiments, the EPE 332 references a data store (not illustrated for purposes of brevity) to retrieve a template execution plan, which is augmented based on the set 358 of potential answers and the set 360 of reformulated queries. The execution plan 335 specifies, for example, that certain answer queries are to be sent to certain of answer services 314, 316, and 318. Using the execution plan, the EPE 332 sends answer queries 362, 364, and 366 to answer services 314, 316, and 318, respectively. In response, the answer services 314, 316, and 318 return answers 368, 370, and 372, respectively. As illustrated, the answers 368, 370, and 372 are provided to the ranking engine 340.

The ranking engine 340 ranks the answers 368, 370, and 372. For instance, in an embodiment, the ranking engine 340 ranks the answers 368, 370, and 372 based on relevance to the entity, the user search query 350, or other context associated with the user's search experience. The ranking engine 340, as shown in FIG. 3, provides an ordered set 374 of answers 368, 370, and 372 to the quorum checker 344. As is further illustrated in FIG. 3, the entity card generator 342 generates an entity card 376 and provides the entity card 376 to the quorum checker 344, as well. In some embodiments, the entity card 376 is created offline and simply retrieved by the quorum checker 344 during live implementation.

The quorum checker 344 performs operations to facilitate optimization of the allocated screen real estate associated with the representation of the entity card 376. For instance, in an embodiment, the quorum checker 344 identifies a first subset 378 of content (e.g., answers) that is to be included in the entity card 376. Additionally, the quorum checker 344 can identify a second subset 380 of content that is to be presented to the user as overflow content. The first subset 378 of content and the entity card are provided to the binder 346, which binds the first subset of content to the entity card 376. As illustrated, the binder 346 (or some other component such as, for example, the quorum checker 344) can receive an algorithmic search result 382 from the search engine 320 and bind that result 382 to the entity card 376, as well. As is further illustrated in FIG. 3, the UX 319 receives the completed entity card 384 and overflow content 380 and facilitates providing a search-results page that includes the completed entity card 384 and the overflow content 380 to the user.

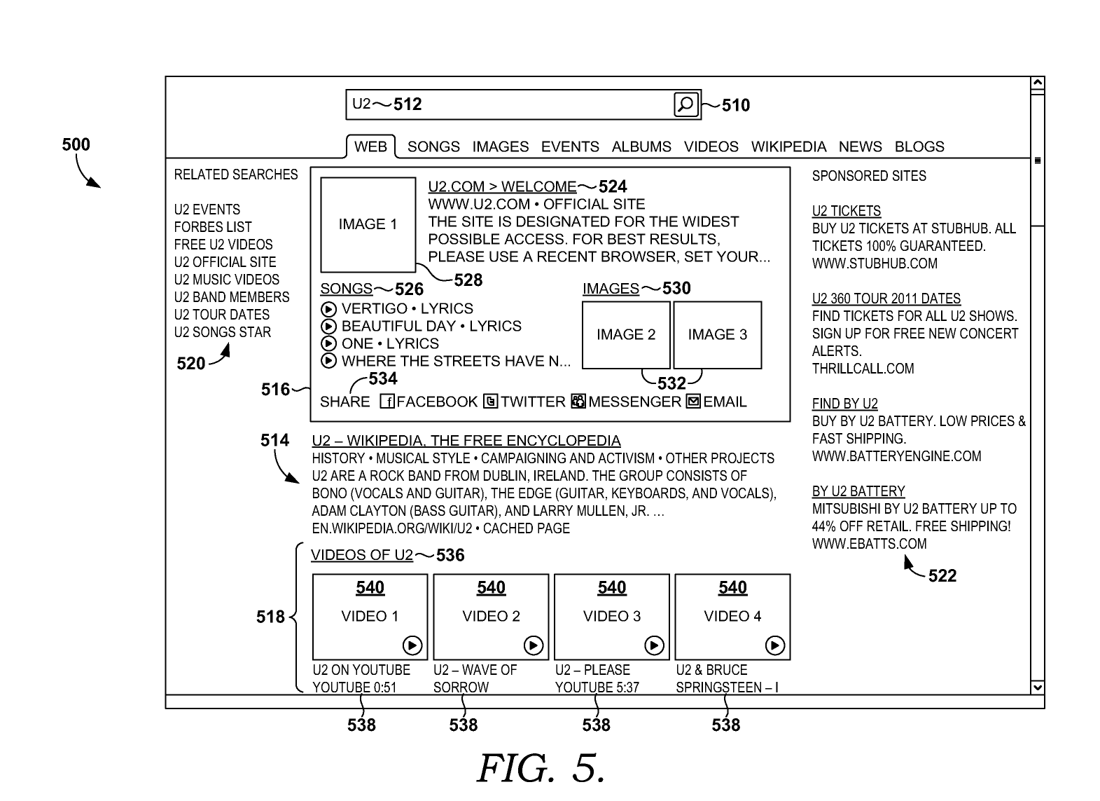

Turning now to FIG. 5 another illustrative search results page 500 is illustrated. As shown in FIG. 5, search results page 500 includes search text input box 510 into which a user has entered the search query 512 consisting of the query string “U2.” As illustrated in FIG. 5, the illustrative search result page 500 also includes a set 514 of algorithmic search results, a presentation 516 of entity card, and a set 518 of overflow content. In an embodiment, overflow content 518 includes content that was determined to be associated with the entity but was not included in the representation 516 of the entity card. As is further illustrated in FIG. 5, the search results page 500 can also include other types of content such as, for example, related searches 520, sponsored sites 522, and the like.

As shown in FIG. 5, the representation 516 of the entity card includes a hyperlink 524 to an official site associated with the identified entity (i.e., the popular Irish rock band U2). Additionally, the representation 516 of the entity card includes a songs answer 526, an image 528 that is related to the entity, a hyperlink 530 for accessing additional images, samples 532 of the additional images, and a set 534 of links that facilitate sharing of the content in the representation 516 of the entity card.

As shown, the overflow content 518 includes a link 536 to videos associated with the entity, as well as links 538 to samples of those videos. In an embodiment, as shown in FIG. 5, the overflow content 518 can also include thumbnails 540 depicting the samples of the videos. In embodiments, other content such as, for example, images, dictionary definitions, and the like, can be included as overflow content 518. Additionally, in various embodiments, the overflow content 518 can be presented in a different location on the search-results page 500. Any number of other arrangements of content can be employed in producing a search-results page 500 that includes a representation 516 of an entity card, all of which are considered to be within the ambit of the invention.

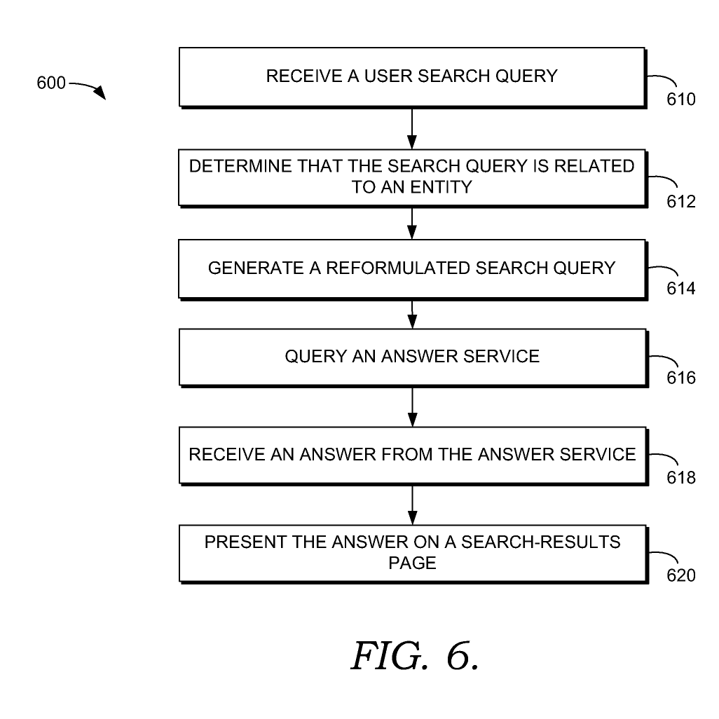

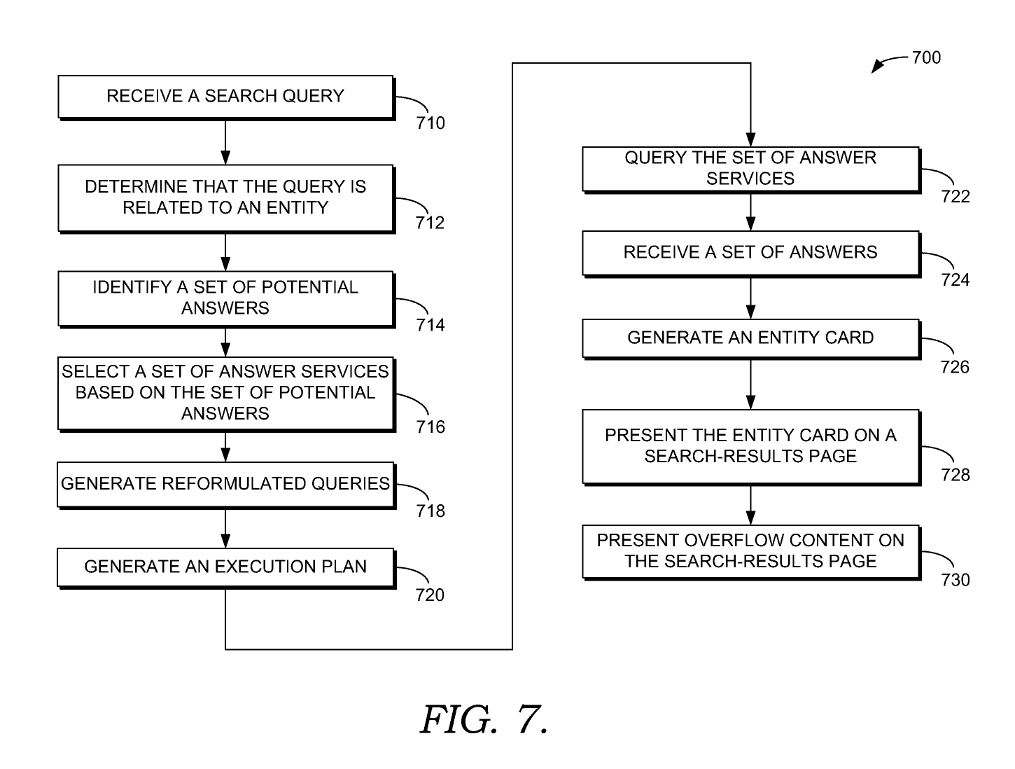

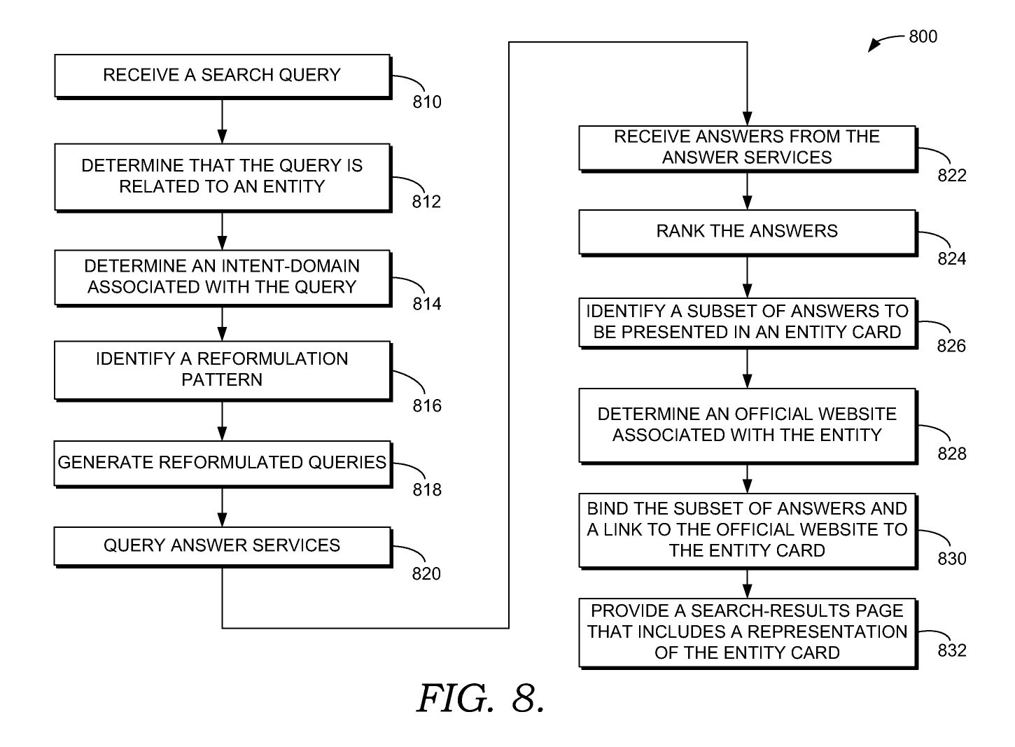

To recapitulate, embodiments of the invention include systems, machines, media, methods, techniques, processes and options for enhancing search results provided in response to a search query by presenting entity-specific content on a search-results page such as, for example, by utilizing entity cards. Turning to FIG. 6, a flow diagram is illustrated that shows an exemplary method 600 for providing entity-specific content to a user according to embodiments of the present invention. In some embodiments, aspects of embodiments of the illustrative method 600 can be stored on computer-readable media as computer-executable instructions, which are executed by a processor in a computing device, thereby causing the computing device to implement aspects of the method 600. The same is, of course true, with the illustrative methods 700 and 800 depicted in FIGS. 7 and 8, respectively, or any other embodiment, variation, or combination of these methods. The computing device can be associated with, for example, a search service or the like.

At a first illustrative step, step 610, a search query is received by a search service. In an embodiment, the search query is submitted by a user utilizing a computing device that communicates with the search service. In other embodiments, the search query can be submitted by a component of the search service, another network entity (e.g., a query suggestion service), or the like. At step 612, the search service determines whether the search query is related to an entity. According to embodiments of the invention, the search service determines whether the search query is related to an entity by utilizing one or more entity classifiers. Entity classifiers can include, for example, linear classifiers, statistical classifier, artificial intelligence, and the like. In some embodiments of the invention, classifiers also are used to identify a category (i.e., domain) corresponding to the entity.

At step 614, a reformulated search query is generated. In an embodiment, a query reformulation engine generates a set of reformulated queries based on the original search query. For example, the reformulated search query can be generated by determining a canonical form of the user search query and, for example, by using the canonical form, and/or derivations thereof, as reformulated search queries. In some embodiments of the invention, the reformulated search queries are generated in a particular manner such as in a manner calculated to return certain answers, answers associated with certain domains, and the like. In embodiments, the search service can interact with a number of answer services, which provide answers to queries originating from the search service.

In some embodiments, the search service also can identify a set of potential answers corresponding to the user search query by referencing a list of potential answers that maybe stored, for example, in a dictionary associated with the search service. In some embodiments, the search service can identify a set of potential answers and generate a reformulated query by determining an intent domain associated with the search query and identifying a reformulation pattern corresponding to the search query. In embodiments, a number of domains can be identified and used to determine reformulation patterns. In some embodiments, reformulated queries are generated by referencing related entities, related domains, and the like. In an embodiment, reformulation patterns are based on the intent domain identified, the string making up the user search query, a list of potential answers, and the like.

At step 616, the search service queries one or more answer services using answer queries, which can, in embodiments, include one or more of the reformulated search queries. In an embodiment, the search service generates an execution plan that specifies a process for retrieving answers from the answer services. For example, in some embodiments, the execution plan includes indications of certain answer services which should be provided with certain answer queries, indications of certain reformulated search queries or other queries that should be sent to the answer service, and any other information relevant to generating answer queries, providing the answer queries to answer services, and processing the answers returned by the queried answer services.

At step 618, an answer is received from an answer service. In an embodiment, the answer can include content such as video, text, audio, images, and the like. In some embodiments, the answer includes a hyperlink to a website (e.g., an official site), a hyperlink to a vertical (domain-specific) search service, or the like. At a final illustrious step, step 620, the answer received from the answer service is presented on a search-results page, which is provided to the user. In an embodiment, the search service generates an entity card, which includes a data structure that defines a layout of content corresponding to the entity. The content included in the entity card can include a subset of a set of answers received from the answer services, content and links corresponding to official sites, entity names, and any other content corresponding to the entity. In an embodiment, the search service presents a representation of the entity card on the search-results page.

Turning now to FIG. 7, another flow chart depicts an illustrative method 700 of presenting entity-specific content to a user. At step 710, a search query is received from a user. At step 712, the search service utilizes a classifier to determine whether the search query is related to an entity. In embodiments, the search service utilizes a number of classifiers. In some embodiments, the search service also utilizes classifiers to identify domains associated with the entity. At step 714, a set of potential answers to the search query is identified and at step 716, a set of answer services is selected based on the set of potential answers.

At step 718, reformulated queries are generated. In embodiments, a set of reformulated queries, based on the user search query, is generated. Reformulated queries can be generated using reformulation patterns, which can be identified by examining web logs and other historical information to determine query patterns that have previously (and, generally, frequently) returned certain answers, certain answer domains, or the like. In some embodiments, the search service identifies a set of potential answers based on the entity. The search service can, according to various implementations, identify related entities that can be used in query reformulation. Sometimes, when users search for information about a certain entity, the users do not enter the exact name of the entity. Identifying related entities can be one way of disambiguating such queries.

According to various embodiments, the list of potential answers can be drawn from any number of different sources. In an embodiment, for example, the list of potential answers can be obtained from information sources outside of the search service, as well. For instance, in an embodiment, the search service references a Wikipedia page associated with the entity. The categories (i.e., domains) and attributes listed on the Wikipedia page can be referenced to identify potential answers. In embodiments, references to official sites associated with the entity can be obtained from the Wikipedia page. Any number of other items of content or information can be obtained by referencing reference sources such as Wikipedia, encyclopedias, dictionaries, other search services, and the like.

In other examples, a user search query can be related to an entity name that corresponds to more than one entity. According to embodiments of the invention, various techniques can be employed to disambiguate the query name. For example, in some embodiments, a search service can reference a number of sources to obtain information useful in disambiguating the entity name. For instance, in an embodiment, the search service can reference query logs to determine domains that commonly are implicated in connection with the entity name. A dominant domain (e.g., the domain most frequently returned in connection with the entity name) can be identified and used to disambiguate the entity name. Any number of other algorithms, heuristics, artificial intelligence schemes, and the like can be utilized to facilitate disambiguation of entity names.

With continued reference to FIG. 7, as shown at step 720, an execution plan is generated. In embodiments, the execution plan specifies a process for obtaining answers to be included in an entity card. For example, in an embodiment, an answer mapping component provides the set of potential answers and a set of reformulated queries to an execution plan engine, which uses the provided information to generate an execution plan. The execution plan can, for example, specify answer queries that are to be provided to certain answer services. In some embodiments, the execution plan can specify orders in which answer queries are to be made, protocols by which answer queries are to be communicated, and the like. In other embodiments, execution plans can be generated offline and stored in dictionaries such that, for example, when a particular entity is identified in a search query, an execution plan corresponding to that entity is retrieved and implemented.

At step 722, the execution plan engine queries a set of answer services based on the execution plan. At step 724, a set of answers is received from the answer services in response to the answer queries. Using at least a portion of the received answers, an entity card is generated, as indicated at step 726. In an embodiment, the entity card includes a data structure that defines a layout of a first portion of content corresponding to the entity. In embodiments, the first portion of content can be determined by ranking answers and selecting from the ranked answers, by performing quorum checking to optimize the utilization of screen real estate, and the like. In some embodiments, a second portion of content is identified and tagged to be presented as overflow content. According to embodiments of the inventions, an official website also is determined such as, for example, by referencing Wikipedia, and a hyperlink is included to the official website and the representation of the entity card. At step 728, a representation of the entity card is presented at a first location on a search-results page and, at step 730, overflow content is presented at a second location on the search-results page.

Turning now to FIG. 8, a flow chart depicts an illustrative method 800 of presenting entity-specific content to a user. At step 810, a search query is received. At step 812, a determination is made as to whether the query is related to an entity. If the query is related to an entity, domains associated with the entity are determined, as indicated at step 814. In embodiments, potential answers, related queries, dominant domains, information about official sites, and the like can also be determined. This information is used, as indicated at step 816, to identify a reformulation pattern. At step 818, the reformulation patterns are utilized to generate a set of reformulated queries.

As shown at step 820, the search service queries one or more answer services by sending answer queries to the services. In an embodiment, the answer queries can include the user search query, the reformulated queries, potential answers, or other types of information. At step 822, the search service receives answers returned from the answer services in response to the answer queries. At step 824, the search service ranks the answers and, as indicated at step 826, a subset of answers is identified to be presented in an entity card. In an embodiment, for example, a quorum checker can be used to identify the subset of answers to be presented. For example, the quorum checker can determine a desired amount of space within the representation of an entity card that should include content (versus, for example, being left blank). Additionally, in embodiments, the quorum checker can impose conditions on the entity card such as, for example, types of content that are to be presented, locations of content, arrangements of content, and the like.

At step 828, an official website associated with the entity is identified. In embodiments, the official website can be identified by examining algorithmic results, web logs, and/or other information sources. As indicated at step 830, the subset of answers and a link to the official website are bound to the entity card. At a final illustrative step, step 832, a search-results page is provided to the user that includes a representation of the entity card.

Various embodiments of the invention have been described to be illustrative rather than restrictive. Alternative embodiments will become apparent from time to time without departing from the scope of embodiments of the inventions. It will be understood that certain features and sub-combinations are of utility and may be employed without reference to other features and sub-combinations. This is contemplated by and is within the scope of the claims.

The invention claimed is:

1. One or more computer-readable media having embodied thereon computer-executable instructions that, when executed by a processor in a computing device associated with a search service, cause the computing device to perform a method of presenting entity-specific content to a user, the method comprising:
receiving a search query, wherein the search query is submitted to the search service by a user;
determining that the search query is related to an entity;
generating a reformulated query based on the search query;
submitting an answer query to an answer service, the answer query including the reformulated query;
receiving an answer from the answer service; and
providing the answer on a search-results page.

2. The media of claim 1, wherein determining that the search query is related to the entity includes employing an entity classifier.

3. The media of claim 2, further comprising identifying a domain corresponding to the entity.

4. The media of claim 3, further comprising identifying a set of potential answers corresponding to the search query.

5. The media of claim 4, further comprising selecting the answer service based on the set of potential answers.

6. The media of claim 5, wherein generating the reformulated query includes identifying a reformulation pattern corresponding to the search query, wherein the reformulation pattern is based on the domain.

7. The media of claim 1, further comprising generating an execution plan, wherein the execution plan includes an indication of the answer service.

8. The media of claim 1, wherein providing the answer on the search-results page includes providing a representation of an entity card, the entity card comprising a data structure that defines an arrangement of content corresponding to the entity.

9. The media of claim 8, further comprising:
determining an official website associated with the entity; and
including a hyperlink to the official website in the representation of the entity card.

10. One or more computer-readable media having embodied thereon computer-executable instructions that, when executed by a processor in a computing device associated with a search service, cause the computing device to perform a method of presenting entity-specific content to a user, the method comprising:
receiving a search query, wherein the search query is submitted to the search service by a user;
determining that the search query is related to an entity;
identifying a set of potential answers corresponding to the search query;
selecting an answer service based on the set of potential answers;
generating a reformulated query based on the search query;
generating an execution plan, wherein the execution plan includes a plan for submitting an answer query to the selected answer service;
providing the answer query to the answer service, wherein the answer query includes the reformulated query;
receiving an answer from the answer service; and
providing the answer on a search-results page.

11. The media of claim 10, wherein generating the reformulated query based on the search query includes:
determining a domain associated with the search query; and
identifying a reformulation pattern corresponding to the search query, wherein the reformulation pattern is based on the domain.

12. The media of claim 11, further comprising generating an entity card, wherein the entity card includes a data structure that defines an arrangement of a first portion of content corresponding to the entity.

13. The media of claim 12, wherein providing the answer on the search-results page includes presenting a representation of the entity card in a first location on the search-results page.

14. The media of claim 13, further comprising presenting overflow content in a second location on the search-results page, wherein the overflow content includes a second portion of content corresponding to the entity.

15. The media of claim 13, further comprising:
determining an official website associated with the entity; and
including a hyperlink to the official website in the representation of the entity card.

16. One or more computer-readable media having embodied thereon computer-executable instructions that, when executed by a processor in a computing device, cause the computing device to perform a method of presenting entity-specific content to a user, the method comprising:
receiving a search query, wherein the search query is submitted to a search service by a user;
determining that the search query is related to an entity;
generating a set of reformulated queries based on the search query;
querying a set of answer services using the set of reformulated queries;
receiving a set of answers from the set of answer services;
ranking the set of answers;
identifying a first subset of the ranked set of answers, wherein said first subset is to be presented to the user;
binding the subset of answers to an entity card, the entity card comprising a data structure that defines a layout of entity-specific content; and
providing a search-results page that includes a representation of the entity card.

17. The media of claim 16, wherein generating the reformulated query includes:
determining a domain associated with the search query; and
identifying a reformulation pattern corresponding to the search query, wherein the reformulation pattern is based on the domain.

18. The media of claim 17, further comprising:
determining an official website associated with the entity; and
including a hyperlink to the official website in the representation of the entity card.

19. The media of claim 18, further comprising identifying overflow content, the overflow content comprising a second subset of the ranked set of answers, wherein said first and second subsets are mutually exclusive.

20. The media of claim 19, further comprising presenting the overflow content on the search-results page, wherein the entity card is presented at a first location on the search-results page and the overflow content is presented at a second location on the search-results page.
